(19) United States
(12) Patent Application Publication
(10) Pub. No.: US 2026/0219931 A1
(43) Pub. Date: Jul. 30, 2026

(54) METHOD AND AN ELECTRONIC DEVICE FOR RECOVERING MEMORY

(71) Applicant: SAMSUNG ELECTRONICS CO., LTD., Suwon-si (KR)

(72) Inventors: Irfan ABDUL, Bangalore (IN); Anuradha KANUKOTLA, Bangalore (IN); Syama SUDHEESH, Bangalore (IN); Aditi JAISWAL, Bangalore (IN); Nareh Kumar NARASIMMAMOORTHY, Bangalore (IN); Sripurna MUTALIK, Bangalore (IN)

(73) Assignee: SAMSUNG ELECTRONICS CO., LTD., Suwon-si (KR)

(21) Appl. No.: 19/573,660

(22) Filed: Mar. 20, 2026

Related U.S. Application Data
(63) Continuation of application No. PCT/KR2024/014179, filed on Sep. 20, 2024.

(30) Foreign Application Priority Data
Sep. 20, 2023 (IN) 202341063018
Aug. 27, 2024 (IN) 202341063018

(51) Int. Cl. G06F 9/50

(52) U.S. Cl. CPC G06F 9/5022

(57) ABSTRACT

A method may include detecting an event associated with an idle state of one or more processes in the electronic device. The method may include analyzing memory consumption associated with each of the one or more processes with the idle state, based on detecting the event. The method may include determining the memory consumption associated with the processes exceeds a memory consumption threshold, based on analyzing the memory consumption. The method may include predicting a first time value corresponding to the idle state for each of the one or more processes in response to the memory consumption exceeding the memory consumption threshold. The method may include identifying the time value exceeding an idle time threshold, based on predicting the time value corresponding to the idle state. The method may include recovering, one or more regions in memory based on identifying the time value exceeding the idle time threshold.

### CROSS-REFERENCE TO RELATED APPLICATIONS

This application is a Continuation Application of International Application PCT/KR2024/014179 filed on Sep. 20, 2024, which claims benefit of Indian Provisional Patent Application No. 202341063018 filed on Sep. 20, 2023, at the Indian Patent Office, and Indian Patent Application No. 202341063018 filed on Aug. 27, 2024, at the Indian Patent Office, the disclosures of which are incorporated herein in their entireties by reference.

### FIELD

The present disclosure generally relates to memory management in electronic devices. In particular, the present disclosure relates to a method and a system for recovering memory in an electronic device.

### BACKGROUND

The information disclosed in this background section is only for enhancement of understanding of the general background of the disclosure and should not be taken as an acknowledgement or any form of suggestion that this information forms the prior art already known to a person skilled in the art.

In an electronic device, a memory is a limited and key resource associated with application performance. The shortage of the memory negatively impacts the performance of an application in the electronic device. In the existing techniques, memory shortage of active applications in the electronic device is usually handled by removing background applications from the memory of the electronic device completely. The process of removing background application from the memory of the electronic device completely is associated with terminating the background application. The problem with terminating background applications is a negative impact on the user experience on reloading the application again.

In the existing techniques, a memory recovery process is reactive in nature. That is, the memory recovery is triggered when the available memory on the electronic device is insufficient to support the active applications. In the existing techniques, the memory recovery process is usually performed in stages. In a first stage, a swap reclaimer is triggered to reclaim Random Access Memory (RAM) by moving the least used pages to a swap area. In the next stage, if the memory is not sufficient then a direct reclaimer is triggered. The direct reclaimer reclaims the memory by discarding pages associated with inactive background applications. Thereafter, if the memory available at the electronic device is still not sufficient then an application termination is triggered. The application termination removes the background applications to free up memory in the electronic device.

In existing techniques, user experience is further impacted as the active (applications in the foreground of the electronic device) experience sluggishness during the memory recovery process. The problem is even more evident in the case of memory-intensive applications such as gaming applications. In case of memory intensive applications the electronic device usually triggers the application termination to meet the memory requirement resulting in a bad user experience.

Thus, there is a need to provide a methodology to overcome the above-mentioned issues in the conventional techniques and a system to perform the methodology.

### SUMMARY

This summary is provided to introduce a selection of concepts in a simplified format that are further described in the detailed description of the invention. This summary is not intended to identify essential inventive concepts of the invention, nor is it intended to determine the scope of the invention.

According to an embodiment of the disclosure, the method for recovering memory in an electronic device is provided. According to an embodiment of the disclosure, the method may include detecting, by the electronic device, an event associated with an idle state of one or more processes in the electronic device. According to an embodiment of the disclosure, the method may include analyzing, by the electronic device, memory consumption associated with each of the one or more processes with the idle state, based on detecting the event. According to an embodiment of the disclosure, the method may include determining, by the electronic device, the memory consumption associated with the one or more processes exceeds a memory consumption threshold, based on analyzing the memory consumption. According to an embodiment of the disclosure, the method may include predicting, by the electronic device, a first time value corresponding to the idle state for each of the one or more processes in response to the memory consumption exceeding the memory consumption threshold. According to an embodiment of the disclosure, the method may include identifying, by the electronic device, the first time value exceeding an idle time threshold, based on predicting the first time value corresponding to the idle state. According to an embodiment of the disclosure, the method may include recovering, by the electronic device, one or more regions in memory of the electronic device based on identifying the first time value exceeding the idle time threshold, such that the recovery of memory in the electronic device is associated with enhanced memory performance at the electronic device.

According to an embodiment of the disclosure, an electronic device may include at least one processor including processing circuitry, memory storing instructions that, when executed by the at least one processor individually or collectively is provided. According to an embodiment of the disclosure, the instructions may be that, when executed by the at least one processor individually or collectively, may cause the electronic device to detect an event associated with an idle state of one or more processes in the electronic device. According to an embodiment of the disclosure, the instructions may be that, when executed by the at least one processor individually or collectively, may cause the electronic device to analyze memory consumption associated with each of the one or more processes with the idle state, based on detecting the event. According to an embodiment of the disclosure, the instructions may be that, when executed by the at least one processor individually or collectively, may cause the electronic device to determine the memory consumption associated with the one or more processes exceeds a memory consumption threshold, based on analyzing the memory consumption. According to an embodiment of the disclosure, the instructions may be that, when executed by the at least one processor individually or collectively, may cause the electronic device to predict a first time value corresponding to the idle state for each of the one or more processes in response to the memory consumption exceeding the memory consumption threshold. According to an embodiment of the disclosure, the instructions may be that, when executed by the at least one processor individually or collectively, may cause the electronic device to identify the first time value exceeding an idle time threshold, based on predicting the first time value corresponding to the idle state. According to an embodiment of the disclosure, the instructions may be that, when executed by the at least one processor individually or collectively, may cause the electronic device to recover one or more regions in memory of the electronic device based on identifying the first time value exceeding the idle time threshold, such that the recovery of memory in the electronic device is associated with enhanced memory performance at the electronic device.

According to an embodiment of the disclosure, a computer readable medium storing one or more instructions is provided. According to an embodiment of the disclosure, the instructions may be that, when executed by the at least one processor individually or collectively, may cause the electronic device to detect an event associated with an idle state of one or more processes in the electronic device. According to an embodiment of the disclosure, the instructions may be that, when executed by the at least one processor individually or collectively, may cause the electronic device to analyze memory consumption associated with each of the one or more processes with the idle state, based on detecting the event. According to an embodiment of the disclosure, the instructions may be that, when executed by the at least one processor individually or collectively, may cause the electronic device to determine the memory consumption associated with the one or more processes exceeds a memory consumption threshold, based on analyzing the memory consumption. According to an embodiment of the disclosure, the instructions may be that, when executed by the at least one processor individually or collectively, may cause the electronic device to predict a first time value corresponding to the idle state for each of the one or more processes in response to the memory consumption exceeding the memory consumption threshold. According to an embodiment of the disclosure, the instructions may be that, when executed by the at least one processor individually or collectively, may cause the electronic device to identify the first time value exceeding an idle time threshold, based on predicting the first time value corresponding to the idle state. According to an embodiment of the disclosure, the instructions may be that, when executed by the at least one processor individually or collectively, may cause the electronic device to recover one or more regions in memory of the electronic device based on identifying the first time value exceeding the idle time threshold, such that the recovery of memory in the electronic device is associated with enhanced memory performance at the electronic device.

According to an embodiment of the disclosure, provided is a method for recovering memory in an electronic device, the method including: detecting, by the electronic device, an event associated with an idle state of a first process in the electronic device; analyzing, by the electronic device, memory consumption associated with the first process in the idle state, based on the detecting the event; determining, by the electronic device, the memory consumption associated with the first process exceeding a memory consumption threshold, based on the analyzing the memory consumption; predicting, by the electronic device, a first time value corresponding to the idle state for the first process in response to the memory consumption exceeding the memory consumption threshold; identifying, by the electronic device, the first time value exceeding an idle time threshold, based on predicting the first time value corresponding to the idle state; and recovering, by the electronic device, one or more regions in memory of the electronic device based on identifying the first time value exceeding the idle time threshold, such that the recovered one or more regions in memory are available for use by another process.

According to an embodiment of the disclosure, provided is an electronic device including: at least one processor including processing circuitry, memory storing instructions that, when executed by the at least one processor individually or collectively, cause the electronic device to: detect an event associated with an idle state of a first process in the electronic device; analyze memory consumption associated with each of the first process with the idle state, based on detecting the event; determine the memory consumption associated with the first process exceeding a memory consumption threshold, based on analyzing the memory consumption; predict a first time value corresponding to the idle state for the first process in response to the memory consumption exceeding the memory consumption threshold; identify the first time value exceeding an idle time threshold, based on predicting the first time value corresponding to the idle state; and recover one or more regions in memory of the electronic device based on identifying the first time value exceeding the idle time threshold, such that the recovered one or more regions in memory are available for use by another process.

According to an embodiment of the disclosure, provided is a computer readable medium storing one or more instructions, wherein the one or more instructions, when executed by at least one processor, cause the at least one processor of an electronic device to: detect an event associated with an idle state of a first process in the electronic device; analyze memory consumption associated with first process with the idle state, based on detecting the event; determine the memory consumption associated with the first process exceeding a memory consumption threshold, based on analyzing the memory consumption; predict a first time value corresponding to the idle state for each of the first process in response to the memory consumption exceeding the memory consumption threshold; identify the first time value exceeding an idle time threshold, based on predicting the first time value corresponding to the idle state; and recover one or more regions in memory of the electronic device based on identifying the first time value exceeding the idle time threshold, such that the recovered one or more regions in memory are available for use by another process.

To further clarify the advantages and features of the present invention, a more particular description of the invention will be rendered by reference to specific embodiments thereof, which is illustrated in the appended drawing. It is appreciated that these drawings depict only typical embodiments of the invention and are therefore not to be considered limiting its scope. The invention will be described and explained with additional specificity and detail with the accompanying drawings.

### BRIEF DESCRIPTION OF DRAWINGS

These and other features and aspects of the present invention will become better understood when the following detailed description is read with reference to the accompanying drawings in which like characters represent like parts throughout the drawings, wherein:

FIG. 1A illustrates environments for the implementation of a system for recovering memory in an electronic device, according to various embodiments of the present disclosure;

FIG. 1B illustrates environments for the implementation of a system for recovering memory in an electronic device, according to various embodiments of the present disclosure;

FIG. 2 illustrates an exemplary general architecture of the system, according to various embodiments of the present disclosure;

FIG. 3 illustrates a high-level architecture of modules and components of the system of FIG. 2, according to various embodiments of the present disclosure;

FIG. 4 illustrates a process flow diagram associated with a memory analysis module of the system, according to various embodiments of the present disclosure;

FIG. 5 illustrates a process flow diagram associated with a first time memory recovery for an application in an idle state, according to various embodiments of the present disclosure;

FIG. 6 illustrates a process flow diagram associated with a subsequent memory recovery for the application in the idle state, according to various embodiments of the present disclosure;

FIG. 7 illustrates a process flow diagram associated with a process Idle Time (PIT) prediction module of the system, according to various embodiments of the present disclosure;

FIG. 8 illustrates a block diagram associated with a training process idle time prediction model, according to various embodiments of the present disclosure;

FIG. 9 illustrates a process flow diagram associated with a process idle time prediction to trigger a memory recovery process, according to various embodiments of the present disclosure;

FIG. 10 illustrates a process flow associated with a memory recovery module of the system, according to various embodiments of the present disclosure;

FIG. 11 illustrates an exemplary use case of the present disclosure associated with a post boot memory optimization in the electronic device, according to various embodiments of the present disclosure;

FIG. 12 illustrates an exemplary use case of the present disclosure associated with memory optimization in the electronic device executing a memory intensive application, according to various embodiments of the present disclosure; and

FIG. 13 illustrates an exemplary process flow comprising a method for recovering memory in the electronic device, according to various embodiments of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION

It should be understood at the outset that although illustrative implementations of the embodiments of the present disclosure are illustrated below, the present invention may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims along with their full scope of equivalents.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments, to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching, and illuminating some embodiments and their specific features and elements and does not limit, restrict, or reduce the spirit and scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way, it may still be referred to as “one or more features” or “one or more elements” or “at least one feature” or “at least one element.” Furthermore, the use of the terms “one or more” or “at least one” feature or element does NOT preclude there being none of that feature or element, unless otherwise specified by limiting language such as “there NEEDS to be one or more . . . ” or “one or more element is REQUIRED.”

Unless otherwise defined, all terms, and especially any technical and/or scientific terms, used herein may be taken to have the same meaning as commonly understood by one having ordinary skill in the art.

Embodiments of the present invention will be described below in detail with reference to the accompanying drawings.

According to an embodiment, the present disclosure discloses a method and a system for recovering memory in an electronic device.

As used herein, an idle state of one or more processes is associated with processes in a background of the electronic device and marked as inactive by the electronic device.

As used herein, the one or more processes may include applications/processes executed by the electronic device, post boot processes running in the background of the electronic device, and the processes in background when the electronic device is running memory intensive processes. For example, the memory intensive processes may include gaming related processes and generative artificial intelligence (AI) related processes running on the electronic device.

The terms “process” and “application” are used interchangeably in the present disclosure and may be associated with applications or processes being executed or performed by the electronic device.

The detailed methodology of the disclosure is explained in the following paragraphs.

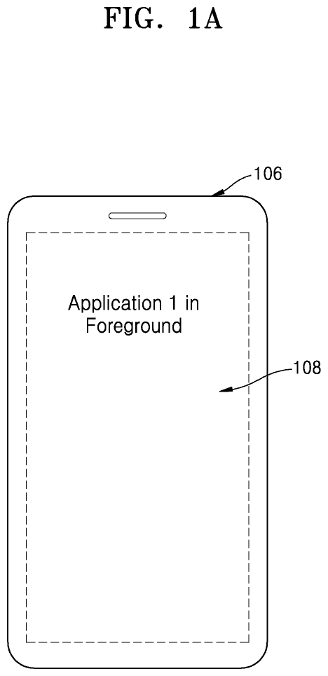

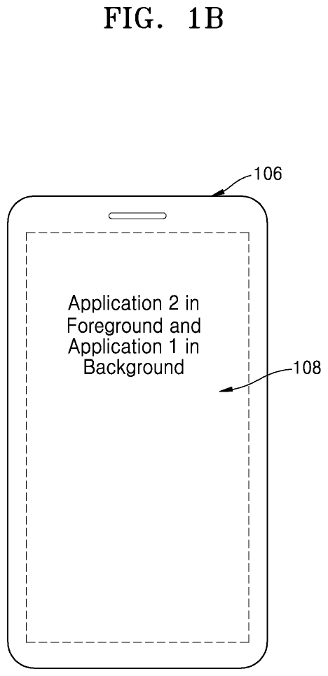

FIGS. 1A-1B illustrate environments for the implementation of a system for recovering memory in an electronic device, according to various embodiments of the present disclosure.

According to an embodiment, a user 104 may be engaged in an interaction with the electronic device 106. The user 104 is not illustrated in the FIGS. 1A-1B for the sake of clarity. The term “electronic device” and term “User Device” may be used interchangeably with in a scope of the present disclosure. In a non-limiting example, the electronic device 106 may be a laptop computer, a desktop computer, a Personal Computer (PC), a notebook, a smartphone, a tablet, a smartwatch, a smart television, or any device capable of executing the one or more processes and requires memory management. In the existing memory recovery techniques, the memory recovery is triggered in response to memory shortages. The electronic device 106 faces sluggish scenarios due to a shortage of available memory. In such scenarios, the electronic device 106 is busy recovering memory in the background.

Referring to FIG. 1A, an exemplary scenario of the present disclosure is depicted. In the FIG. 1A an application (or process) namely an application 1 is being executed by the electronic device 106 in the foreground and is available to the user 104 over a user interface (UI) 108.

Further, referring to FIG. 1B, a scenario is depicted as an example, wherein the solution of the present disclosure is applied to an exemplary scenario. In the FIG. 1B, the application 1 is moved to the background of the electronic device 106, and a second application e.g., an application 2 is executing on foreground of the electronic device 106. Further, when an application goes to the background, the electronic device 106 uses an application freeze technique. The application freeze technique is used to restrict the CPU cycle for the frozen application. The application in the background in the frozen state is also termed as an application (or process) in the idle state. In the exemplary scenario, the application 1 is in the electronic device background and is in an idle state (or frozen state). The present disclosure provides the system and a method to recover memory from the application 1, when the application 1 is in the idle state. In an embodiment, the recovered memory is available for use by an application or a process.

The present disclosure use a process or application idle time prediction method. The process idle time prediction method is implemented using an AI model to predict the idle time associated with application 1. The present disclosure is further configured to perform memory scanning in the electronic device 106. The memory scan is done to identify memory sections of application 1 in the idle state for marking. Furthermore, the present disclosure provide a memory recovery method to recover memory. The memory recovery method of the present disclosure is executed without any disruption to an active foreground application e.g. the application 2.

The present disclosure recovers memory from applications in the idle state (e.g. application 1) based on factors such as estimated memory recovery size and predicted idle time for one or more processes. For example, inputs to a system based on the present disclosure may include an identifier (ID) for the one or more processes in the idle state, an idle time duration for the one or more processes, current out of memory adjusted (oomadj) score for the one or more processes. Other inputs may include memory usage in the electronic device 106, electronic device 106 memory pressure stall information (PSI), network usage by the electronic device 106, ID for process executing on the electronic device foreground, and associated memory regions. The present disclosure optimize the memory usage at the electronic device 106 based on the inputs.

The present disclosure is application that is applicable to scenarios where multiple applications are executed on the electronic device 106 simultaneously. In an exemplary use case, a user 104 is using application 1 and browsing posts on the application 1. From a notification in the UI 108, the user 104 switches to application 2. After using application 2 for some time, the user 104 again relaunches application 1 on the electronic device foreground, e.g., moves the application 1 to the foreground. Thereafter, the application 1 is again moved to the background, and an application 3 is launched.

The solution as provided in the present disclosure may be exemplified through 4 scenarios as described below:
Scenario 1: The application 1 is in the idle state (frozen state). The predicted idle time based on the present disclosure is less than idle time threshold (e.g., 5 minutes). In such a scenario, the present disclosure will not initiate memory recovery from the application 1. The memory recovery is avoided as based on the prediction the application is expected to recover from idle state in short duration.
Scenario 2: The application 2 enters the idle state and the predicted idle time based on the present disclosure is greater than idle time threshold (e.g., 30 minutes). Such a scenario triggers a memory scan. Further, if the expected recoverable memory is greater than a predefined threshold the present disclosure recovers memory from the application 2. In an example, the predefined threshold for memory recovered is 1 MB and an expected recoverable memory is 60 MB. The recovery of the memory associated with application 2 in the idle state is triggered.
Scenario 3: The application 2 recovers from the idle state (e.g., is moved to the foreground) and re-enters idle state. The application 2 may re-enter idle state due to notification or call at the electronic device. The predicted idle time for application 2 is greater than idle time threshold (e.g., 30 minutes) and the expected recoverable memory is less than predefined threshold for memory recovered (e.g., 1 MB). The expected recoverable memory is less than predefined threshold for memory recovered (e.g., 1 MB), so no memory recovery is triggered for application 2 if the predefined threshold for memory recovery is 1 MB.
Scenario 4: The application 1 is in the idle state and the predicted idle time is greater than idle time threshold (e.g., 30 minutes). Further, the expected recoverable memory is 115 MB. The present disclosure will trigger memory recovery from application 1 as the predicted idle time is greater than time value threshold. Further, the recoverable memory is greater than predefined threshold for memory recovery (e.g. 1 MB). The factors considered in determining the time value threshold is provided in the explanation of the respective module used in the implementation of the present disclosure.

According to the idle time threshold may be set differently for upper threshold and lower threshold.

A detailed methodology to recover memory in the electronic device 106 is explained in the following paragraphs of the disclosure.

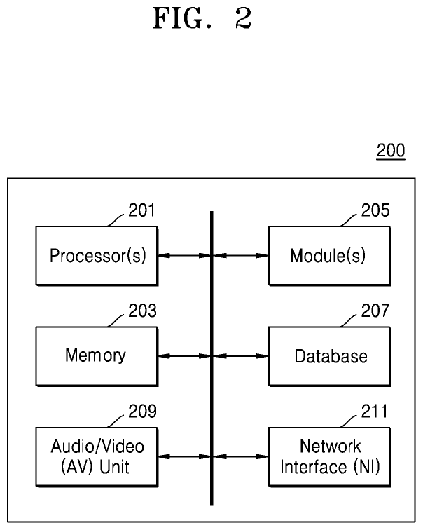

FIG. 2 illustrates an exemplary general architecture of the electronic device 200 for recovering memory, according to various embodiments of the present disclosure. The electronic device 200 may referred to as the electronic device 106 described in FIG. 1. The electronic device 200 includes at least one processor(s) 201, a memory 203, a module(s) 205, a database 207, an Audio/Video (AV) unit 209, and a network interface (NI) 211 coupled with each other.

As an example, the electronic device 200 may be implemented in the electronic device 106 shown in FIG. 1A-1B. In non-limiting examples, the electronic device 200 may be implemented in one or more electronic devices such as the laptop computer, the desktop computer, the Personal Computer (PC), the notebook, the smartphone, the tablet, the smartwatch, the smart television or any other machine capable of executing a set of instructions related to the implementation of the method for recovering memory. According to some embodiment, the electronic device 200 may be implemented at a cloud server which is further connected with the Personal Computer (PC), a desktop computer, and the like for recovering memory.

In an example, the at least one processor 201, alternatively referred to as the processor for the sake of brevity, maybe a single processing unit or a number of units, all of which could include multiple computing units. The processor 201 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor 201 is configured to fetch and execute computer-readable instructions and data stored in the memory 203.

The processor 201 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The memory 203 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

As an example, the module(s) 205 may include a program, a subroutine, a portion of a program, a software component, or a hardware component capable of performing a stated task or function. As used herein, the module(s) 205 may be implemented on a hardware component such as a server independently of other modules, or a module can exist with other modules on the same server, or within the same program. The module(s) 205 may be implemented on a hardware component such as processor one or more microprocessors, microcomputers, microcontrollers, digital signal processors, central processing units, state machines, logic circuitries, and/or any devices that manipulate signals based on operational instructions. The module(s) 205 when executed by the processor(s) 201 may be configured to perform any of the described functionalities in accordance with the present disclosure.

As a further example, the database 207 may be implemented with integrated hardware and software. The hardware may include a hardware disk controller with programmable search capabilities or a software system running on general-purpose hardware. The examples of the database 207 are, but are not limited to, in-memory databases, cloud databases, distributed databases, embedded databases, and the like. The database 207, amongst other things, serves as a repository for storing data processed, received, and generated by one or more of the processors, and the modules/engines/units.

In an embodiment, the module(s) 205 may be implemented using one or more AI modules that may include a plurality of neural network layers. Examples of neural networks include but are not limited to, Convolutional Neural Network (CNN), Deep Neural Network (DNN), Recurrent Neural Network (RNN), Restricted Boltzmann Machine (RBM). Further, ‘learning’ may be referred to in the disclosure as a method for training a predetermined target device (for example, a robot) using a plurality of learning data to cause, allow, or control the target device to make a determination or prediction. Examples of learning techniques include but are not limited to supervised learning, unsupervised learning, semi-supervised learning, or reinforcement learning. At least one of a plurality of CNN, DNN, RNN, RMB models and the like may be implemented to thereby achieve execution of the present subject matter's mechanism through an AI model. A function associated with an AI module may be performed through the non-volatile memory, the volatile memory, and the processor. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). One or a plurality of processors control the processing of the input data in accordance with a predefined operating rule or artificial intelligence (AI) model stored in the non-volatile memory and the volatile memory. The predefined operating rule or artificial intelligence model is provided through training or learning.

As an example, the AV unit 209 receives audio data and video data from any third party. As a further example, the NI unit 211 establishes a network connection with a network like a home network, a public network, or a private network and the like.

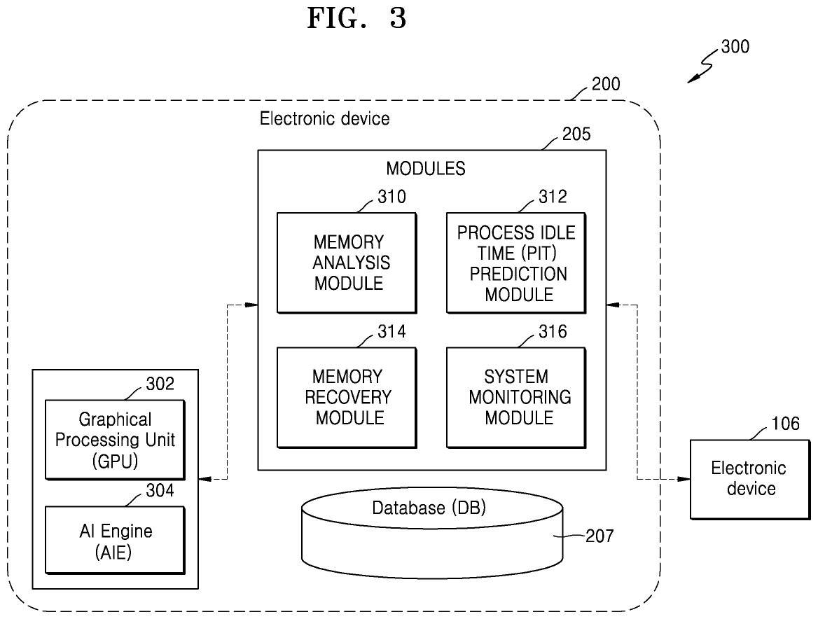

FIG. 3 illustrates a high-level architecture of module(s) 205 and components of the electronic device 200 of FIG. 2, according to various embodiments of the present disclosure. In an embodiment, the module(s) 205 of the electronic device 200 further include a Memory Analysis Module (MAM) 310, a Process Idle Time (PIT) Prediction Module 312, a Memory Recovery Module (MRM) 314, and a System Monitoring Module 316 coupled and collectively operating with each other. The aforementioned modules 205 are further coupled with the graphical processing unit 302, an Artificial Intelligence (AI) engine 304, the database 207, and the electronic device 106 and collectively operate with each other.

The system monitoring module 316 monitors the electronic device 200 events. The event may refer to the system condition or the system state change. The events may include such as application launch, CPU pressure stall information (e.g. CPU load), electronic device temperature and the like. The system state change may include a change to a foreground state, background state or frozen state. For example, the inputs to the system monitoring module 316 may include system events, CPU-related data, thermal and battery data for the electronic device. In the example, the output from the system monitoring module 316 may include the identification of events such as application launch event, high CPU usage event, high-temperature event, and the like at the electronic device 106.

In an embodiment, the memory analysis module 310 may be configured to optimize processor 201 time by estimating target memory for recovery from the one or more processes in the idle state. For example, the inputs to the memory analysis module 310 may include current memory consumption for the one or more processes, and previous recorded memory consumption for the one or more processes. The memory consumption may be recorded as a dataset, an image, or in a database. In the example, the output from the memory analysis module 310 may include estimated memory size to be recovered by the system of the present disclosure.

In the embodiment, the memory analysis module 310 may be further connected to a memory analysis module (MAM) queue. The MAM queue may be configured to store memory analysis module 310 related requests to defer the MAM process. The MAM process may be deferred based on the events identified by the system monitoring module 316 or multiple memory analysis requests pending for multiple processes. The inputs to the MAM queue may include events identified by the system monitoring module 316 such as application launch, High CPU usage, high temperature at the electronic device, and the like. The output from the MAM queue may include adding an ID for the one or more processes to the MAM queue.

In an embodiment, the process idle time prediction module 312 may be configured to estimate the idle time associated with the one or more processes in the idle state. The estimation is performed by an artificial intelligence (AI) based machine learning (ML) model. In an example, the prediction by the ML model may be based on factors such as the process frozen event time, application out of memory killer (e.g., oom_adj) score, system memory usage, system memory pressure stall information (PSI), network usage at electronic device 106, foreground application ID, a past record associated with the reason of unfreeze (or recovery from the idle state). In the example, the output from the process idle time prediction module 312 may include the idle time duration for the one or more processes.

In the embodiment, the process idle time prediction module 312 may be further connected to the process idle time (PIT) queue. The PIT queue may be configured to store process idle time module related request to defer the process idle time prediction. The PIT prediction process is deferred based on the events identified by the system monitoring module 316 or multiple requests pending for multiple processes. The inputs to the PIT queue may include the events identified by the system monitoring module 316 such as application launch, High CPU usage, high temperature at the electronic device, and the like. The output from the PIT queue may include adding an ID for the one or more processes to the PIT queue.

In an embodiment, the memory recovery module 314, may be configured to scan a memory table associated with one or more processes in the idle state. The module 314 further identifies specific memory regions associated with the one or more processes. The identified memory regions when recovered by the module will not impact relaunch of the one or more processes. In an example, the inputs to the memory recovery module 314 may include the type of memory pages (e.g., file page or anon page), the access type of the memory page (e.g., private or shared), the memory page access frequency, and the memory page access age. The memory page in the example is identified to be associated with the one or more processes in the idle state. The output from the memory recovery module 314 may include the advised kernel in the electronic device memory to recover the marked memory regions.

In the embodiment, the memory recovery module (MRM) 314 may be further connected to the memory recovery module (MRM) queue. The MRM queue may be configured to store memory module 314 related requests to defer the memory recovery process. The memory recovery process is deferred based on the events identified by the system monitoring module 316 or multiple requests pending for multiple processes. The inputs to the MRM queue may include the events identified by the system monitoring module 316 such as application launch, High CPU usage, high temperature at the electronic device, and the like. The output from the MRM queue may include adding a process ID for one or more processes to the MRM queue.

The different queues associated with the memory analysis module 310, process idle time prediction module 312, and the memory recovery module 314 are not depicted in FIG. 3 for the sake of clarity.

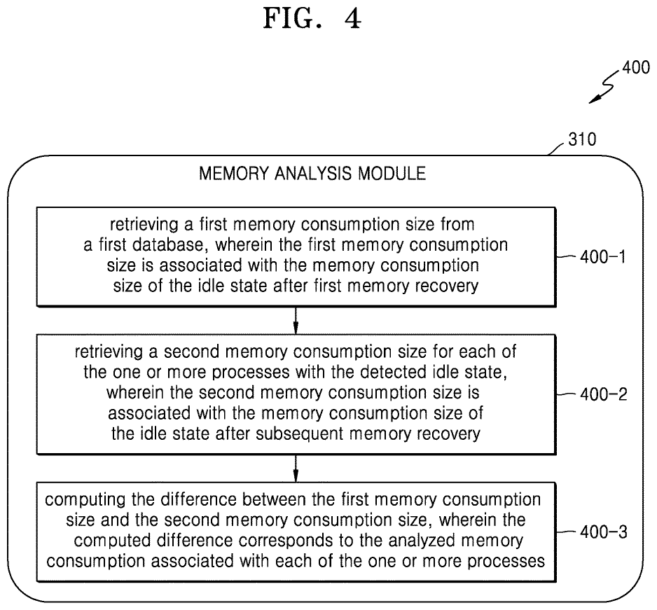

A detailed working and explanation of the various module(s) 205 of FIG. 3 and the detailed working of the electronic device 200 will be explained through various components of FIG. 2 and FIG. 3 in the forthcoming paragraphs through FIGS. 4 to 13.

FIG. 4 illustrates a process flow diagram associated with a memory analysis module of the system, according to various embodiments of the present disclosure.

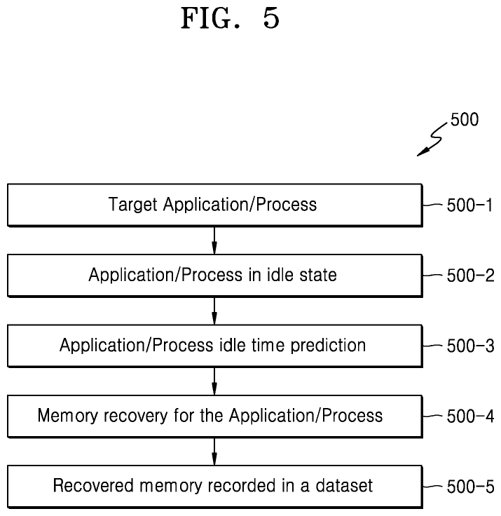

FIG. 5 illustrates a process flow diagram associated with a first time memory recovery for an application in an idle state, according to various embodiments of the present disclosure.

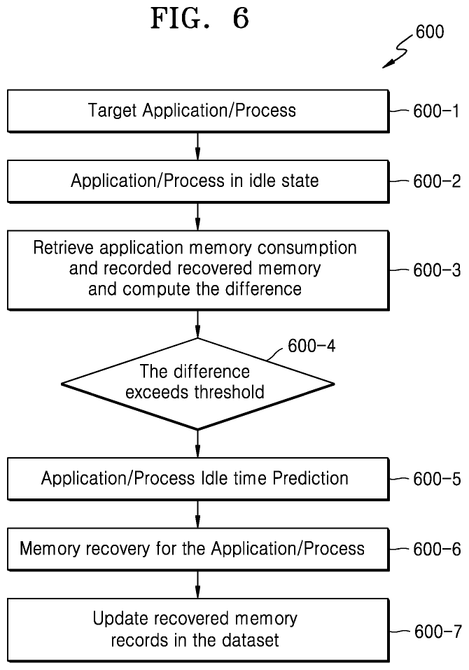

FIG. 6 illustrates a process flow diagram associated with a subsequent memory recovery for the application in the idle state, according to various embodiments of the present disclosure. The FIG. 4 to 6 associated with the memory analysis module are explained together for the sake of better understanding and clarity.

At block 400-1, the memory analysis module 310 may be configured to retrieve first memory consumption size from a first database. A recovered memory size is associated with the memory recovered in a previous event associated with the idle state of each of the one or more processes in the electronic device. The first memory consumption size may refer to the difference between the memory consumption size before the first memory recovery and the recovered memory size in the previous event. The first memory consumption size may refer to the memory consumption of the idle state for the target application or the one or more processes, after the first memory recovery event.

In an exemplary embodiment, during the first time recovery of memory for a process, the electronic device 200 is configured to store the recovered memory size, and the first memory consumption size for the application or one or more processes in a dataset, an image, a memory map, or a database. FIG. 5 illustrates the process of first time memory recovery for a target application/process in the idle state. The process illustrated in FIG. 5 may be termed as “record phase” as the system records the memory recovered size for future reference and comparison. As illustrated at operation 500-1 a target application or process running in the electronic device 106 foreground is identified. At operation 500-2, the target application is identified to enter into the idle state. As the figure illustrates, for the first time memory recovery for the target application, at operation 500-3 the target application idle time is predicted.

Further, at operation 500-4, the system triggers memory recovery for the target application if the predicted idle time exceeds the idle time threshold. A first time value is the predicted idle time value for the target application or the one or more processes. The details related to idle time prediction and first time value are explained with the process idle time prediction module 312. At operation 500-5, the size of the recovered memory is stored in a storage medium (e.g. a dataset or database). According to an embodiment of the disclosure, the memory footprint of the target application or the memory footprint of the target process, after recovery may be stored in the storage medium. Furthermore in the embodiment, the memory analysis module is configured to retrieve the recovered memory size for a previous memory recovery event. For example, the previous memory recovery event may be the first memory recovery event. The previous memory recovery event may also be a memory recovery event prior to the current memory recovery event. The previous memory recovery event may refer to the memory recovery event prior to the most recent recovery, when memory recovery is performed plurality of times for the same application or the same process.

For example, for an application/process A the associated memory is 200 MB. When the application goes to the idle state for the first time, 50 MB of memory is recovered from application A in a memory recovery process. The first memory consumption size for application A is 150 MB. The memory analysis module 310 of the electronic device 200 may be configured to store the recovered memory value in a map data structure.

At block 400-2, the memory analysis module 310 may be configured to retrieve a second memory consumption size for each of the one or more processes with the detected idle state. The second memory consumption size may refer to the memory consumption size of the idle state for the target application or the one or more processes. For example, the second memory consumption size may refer to the memory consumption size of frozen state for the target application after the subsequent (e.g., after the first memory recovery event) memory recovery event. The second memory consumption size is based on the memory consumed by corresponding memory pages associated with each of the one or more processes.

At block 400-3, the memory analysis module 310 may be configured to compute the difference between the first memory consumption size and the second memory consumption size, wherein the computed difference corresponds to the analyzed memory consumption associated with each of the one or more processes.

In the embodiment, for the second or subsequent memory recovery process the first and previous recovered memory size or consumption memory size for the target application serve after the recovery as reference. The operations at block 400-2 and 400-3 are related to FIG. 6 and the same are explained together for clarity. At operation 600-1, the target application is identified. At operation 600-2, the target application is identified in the idle state for a second or subsequent event. At operation 600-3, the memory recovery module 310 retrieves the memory consumption associated with the target application. The module 310 further retrieves the memory consumption size for a first memory recovery event (or another previous memory recovery event). Thereafter, the module 310 computes the difference between the memory consumption associated with the target application and the memory consumption size in a previous memory recovery event.

Further, at operation 600-4 the difference computed at operation 600-3 is compared with the memory consumption threshold. In an example, the memory consumption threshold may be decided as 1 MB. The memory consumption threshold is determined based on the electronic device 106 memory capacity, the recovered memory size associated with one or more processes executed in the electronic device 106, and like factors. If the computed difference based on the analysis by the memory analysis module 310 exceeds the memory consumption threshold, then idle time prediction for the target application is performed at operation 600-5. Thereafter, based on the predicted idle time the memory recovery is performed at operation 600-6. Furthermore, at operation 600-6, the data associated with the current memory recovery process such as the recovered memory size are stored in the dataset or a database as a reference for the subsequent memory recovery process at the electronic device 106.

For example, application A is in the idle state for a second time. The second memory consumption size for application A in the idle state is 190 MB. Based on the previous memory consumption size after recovery (e.g., the first memory consumption size, 150 MB) the memory analysis module 310 computes a difference of the first memory consumption size and the second memory consumption size, 40 MB (e.g., 190 MB−150 MB) as the recoverable memory. Based on the analysis by module 310 the recoverable memory size is around 40 MB. In such a scenario, the analyzed memory exceeds the memory consumption threshold. The memory recovery process is continued for further operations at PIT prediction module 312 and memory recovery module 314.

In an example, the second memory consumption size for application A in the idle state is 150.5 MB. The memory analysis module 310 computes a difference of the first memory consumption size and the second memory consumption size, 0.5 MB (e.g., 150.5 MB−150 MB). In this case, memory recovery will be insignificant and less than the memory consumption threshold (e.g. 1 MB). The electronic device 200 will not trigger further operations in the memory recovery process for application A.

Based on the description for FIG. 4-6, the memory analysis module 310 aims to optimize processing time at the electronic device 106 to recover memory from the one or more processes in the idle state. Module 310 monitors the present memory consumption for a target application in the idle state. The module 310 further compares the present memory consumption with recovered memory size for the target application for a previous memory recovery process. The module 310 aids in the identification of the feasibility of the memory recovery process. Module 310 examines the memory usage patterns for a target application/process and analyses the memory page allocation patterns to assess the feasibility of memory recovery. Furthermore, the module 310 is configured to avoid insignificant memory recovery such as a zero-megabyte (0 MB) memory recovery. This is ensured by comparison to a memory consumption threshold. After the recovery operation, the module is further configured to store the recovered memory size and associated memory information in a dataset (e.g. a memory map) or a database, thereby preserving a record of the memory recovery process for future analysis.

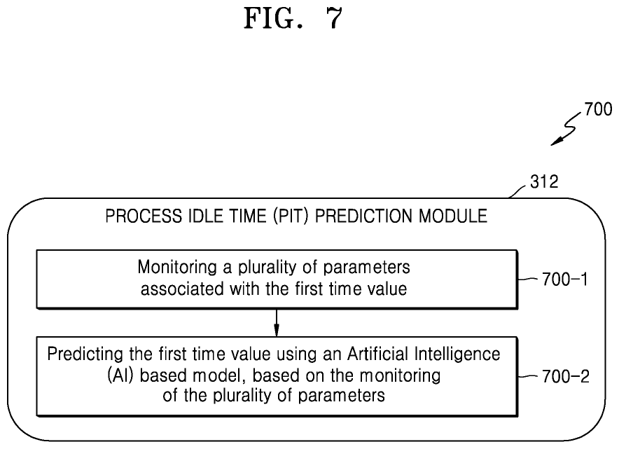

FIG. 7 illustrates a process flow diagram associated with a process idle time (PIT) prediction module of the system, according to various embodiments of the present disclosure.

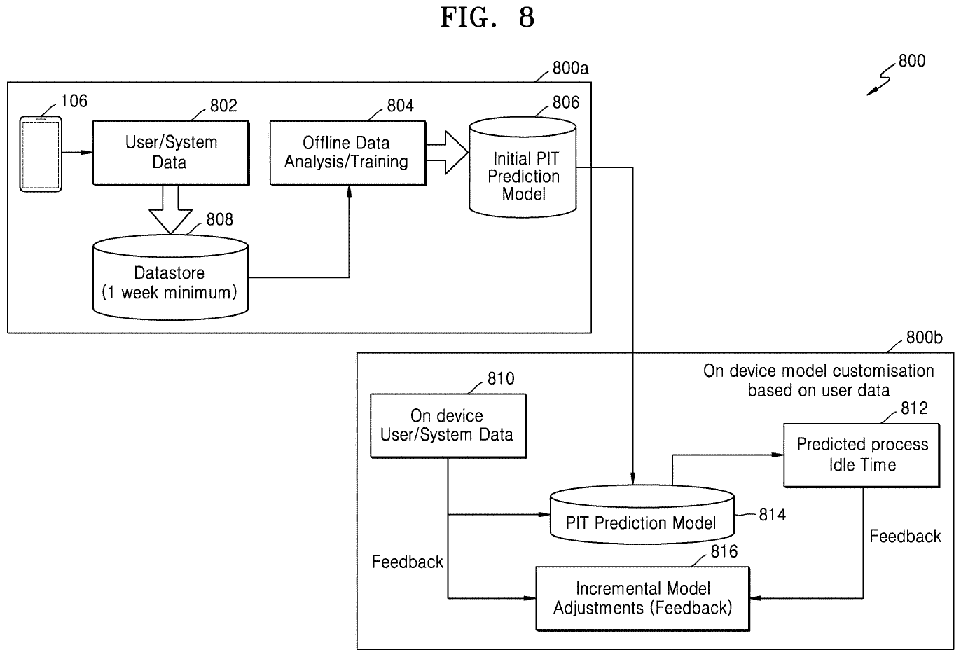

FIG. 8 illustrates a block diagram associated with a training process idle time prediction model, according to various embodiments of the present disclosure.

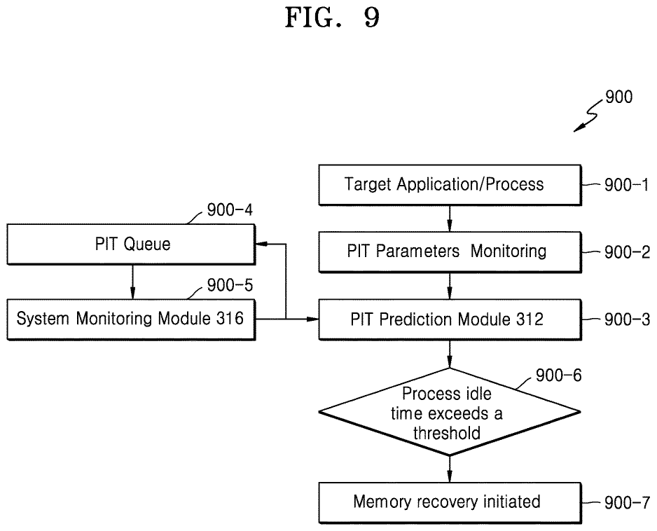

FIG. 9 illustrates a process flow diagram associated with a process idle time prediction to trigger a memory recovery process, according to various embodiments of the present disclosure. FIG. 7 to 9 associated with PIT prediction module 312 are explained together for the sake of better understanding and clarity.

At block 700-1, the process idle time (PIT) module 312 may be configured to monitor a plurality of parameters associated with the first time value.

At block 700-1, the process idle time (PIT) module 312 may be configured to predict the first time value using an Artificial Intelligence (AI) based model, based on the monitoring of the plurality of parameters.

In an exemplary embodiment of the present disclosure, the PIT module 312 is configured to predict the idle time associated with the one or more processes. The process idle time prediction is performed based on the analysis of the recoverable memory by the memory analysis module 310. In an event, the recoverable memory exceeds the memory consumption threshold, and as result, the electronic device 200 triggers the idle time prediction by the PIT module 312. The idle time predicted by the PIT module 312 corresponding to the idle state of the one or more processes is termed as “first time value”.

In the embodiment, the PIT module 312 is implemented using an artificial intelligence (AI) based machine learning (ML) model and may be termed “PIT prediction model” 814. The PIT prediction model is trained to estimate the first time value. FIG. 8 illustrates the PIT prediction model training process. The block 800a illustrates the initial PIT prediction model 806 training performed in the offline mode. The electronic device data 802 associated with the electronic device 106 is stored in a datastore 808. The data store is required to include, for example, at least one week of electronic device data 802 for initial PIT prediction model 806 training. At 804 offline training of the initial PIT prediction model 806 is performed using the data in the datastore 806. For example, the electronic device data 802 includes the application/process usage data and usage pattern, user inputs associated with the process, and background processes/services information. The electronic device data 802 is used for initial training in the offline mode as illustrated in block 800a.

In the block 800b, the initial PIT prediction model 806 is subjected to on-device model training based on the user data to create the PIT prediction model 814. The on-device electronic device (or system) data 810 along with incremental model adjustment (based on feedback) 816 is used to train the PIT prediction model 814. The PIT prediction model 814 is used to process idle time 812 and process idle time may be termed the first time value.

The PIT prediction model 814 predicts the first time value based on the plurality of parameters. In the exemplary embodiment, the plurality of parameters associated with the first time value includes usage pattern analysis parameters and resource utilization monitoring parameters. For example, the usage pattern analysis parameters are associated with recorded data on the application/process usage pattern. Further, the factors considered for usage pattern analysis parameters include the time of day, day of the week, and user behavior during specific tasks on the one or more processes. Further, in the example, the resource utilization monitoring parameters are associated with factors such as electronic device 200 resources (memory, CPU) utilisation, CPU/memory Pressure Stall Information (PSI) levels, network activity, Bluetooth (BT) connectivity state, and the like.

In the exemplary embodiment, the parameters considered for PIT prediction model 814 may include the process ID, the foreground process ID, and the factors associated with the processes in the idle state. The factors associated with process idle state may further include start service, IPC call, start provider, user input, media broadcast event, database access event, start receiver, application on the electronic device 106 foreground, wake lock, and trim memory, application/process type (system or third party), application/process permissions, a time when an application is frozen (idle state) in a day, time when the application is unfrozen (active) in a day, current memory usage at electronic device, current CPU usage, current out of memory adjusted (oomadj) score used by low memory killer to terminate application in low memory situation, memory and CPU Pressure Stall Information (PSI), Network Usage (LTE/Wi-Fi), BT connectivity, application usage time, day of week, and the like.

In a preferred embodiment, the parameters considered for PIT prediction model 814 may include time when application is frozen in a day, current memory usage, current out of memory adjusted (oomadj) score used by low memory killer, memory pressure stall information (PSI), network usage, and foreground application.

Further, as illustrated in process idle time prediction using the PIT prediction model 814. At operation 900-1, a target application/process in the idle state is identified by the electronic device 200. Further, based on the analysis by the memory analysis module 310, the process is identified to have analyzed memory consumption greater than the memory consumption threshold. At operation 900-2, the PIT prediction module 312 implemented via PIT prediction model 814 monitors the plurality of parameters associated with the first time value. The first time value corresponds to the predicted idle time for the one or more processes in the idle state in the electronic device 106 background. In an example, the plurality of parameters associated with the first time value may include total application idle time for a day, foreground application on the electronic device and ID of the foreground application, system memory usage, system memory pressure, current out of memory adjusted (oomadj) score for the application/process, network usage, and the like.

At operation 900-3, the PIT prediction module 312 computes the expected idle time (the first time value) for the target application or process. The PIT prediction module 312 is further connected to the PIT queue as illustrated at operation 900-4 and the system monitoring module 316 at operation 900-5. The working and function of the PIT queue and system monitoring module 316 have been explained in the description for FIG. 3.

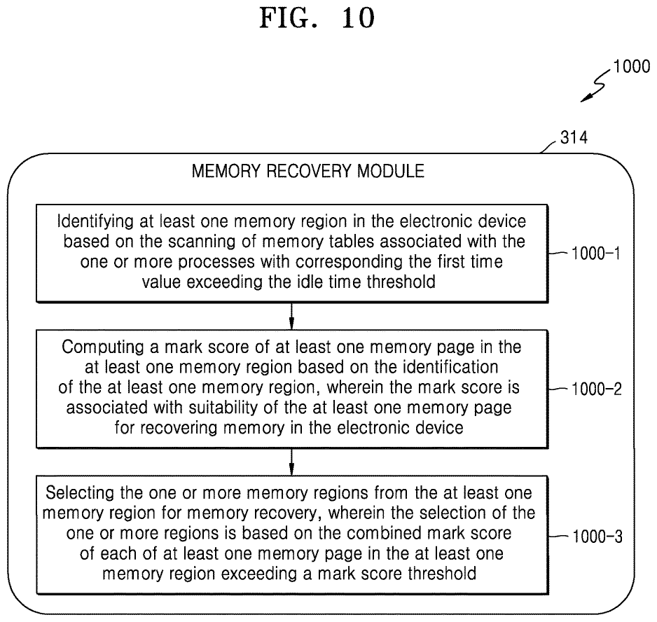

Next, at operation 900-6, the first time value predicted by the PIT prediction module 312 is compared with the idle time threshold. In an event the first time value exceeds the idle time threshold, the electronic device 200 initiates the memory recovery process. The memory recovery process is performed by the memory recovery module 314 at the operation 900-7. The detailed working of the memory recovery is explained in FIG. 10.

In an exemplary embodiment of the present disclosure, the idle time threshold is determined and set based on a plurality of factors. For example, the plurality of factors may include idle time associated with one or more processes in the electronic device, usage pattern of the electronic device and the one or more processes on the electronic device 106 by the user 104. Further, considering the usage pattern as a factor the day is divided into 3 slots (heavy usage, medium usage, low usage). Further in the example, for a heavy usage slot, the idle time threshold may be predefined to be 10 mins. Similarly, for medium usage, the idle time threshold may be predefined to be 20 mins. Furthermore, for low usage slots the idle time threshold may be predefined to be 30 mins.

FIG. 10 illustrates a process flow associated with a memory recovery module of the system, according to various embodiments of the present disclosure.

At block 1000-1, the memory recovery module 314 may be configured to identify at least one memory region in the electronic device based on the scanning of memory tables associated with the one or more processes with corresponding the first time value exceeding the idle time threshold.

At block 1000-2, the memory recovery module 314 may be configured to compute a mark score of at least one memory page in the at least one memory region based on the identification of the at least one memory region, wherein the mark score is associated with suitability of the at least one memory page for recovering memory in the electronic device.

At block 1000-3, the memory recovery module 314 may be configured to select the one or more memory regions from the at least one memory region for memory recovery, wherein the selection of the one or more regions is based on the combined mark score of each of at least one memory page in the at least one memory region exceeding a mark score threshold.

The Mark Score threshold is a normalization value between 0 to 1. For example, the mark score threshold may be predefined to a value of 0.5.

In an exemplary embodiment of the present disclosure, the memory recovery module (MRM) 314 is triggered to recover memory for the one or more processes in the idle state. The MRM 314 is triggered in an event, the first time value exceeds the idle time threshold. MRM 314 systematically scans memory tables in the electronic device 106 associated with the one or more processes. Next, the scan is followed by the identification of memory regions suitable for memory recovery. In the identified memory regions the MRM 314 further computes the mark score of at least one memory page identified memory regions. In an exemplary embodiment, the mark score of the at least one memory page is computed based on type of the at least one memory page, access type of the at least one memory page, access frequency of the at least one memory page, and access age of the at least one memory page.

For example, the type of memory pages corresponds to a file page or an anon page. The access type of the at least one memory page corresponds to a private page or a shared page. Further in the example, let the type of the at least one memory page type be represented as p equals to 1 (one) for a file page and p equals to 0 (zero) for an anon page. The access type of the at least one memory page as a equals to 1 (one) for a private page and a equals to 0 (zero) for a shared page. The access frequency of the at least one memory page may represented as f. The memory pages with the least frequency are preferred for the memory recovery process. The access age of the at least one memory page is represented by n. The memory pages with a greater value of n (age) are preferred for memory recovery. In the example, the mark score for the at least one memory page in the identified one or more memory regions is computed using the equation

$$Mark score for memory page = n ( p * a ) / f \qquad ( 1 )$$

Thereafter in the embodiment, the mark score computed for the at least one memory page is compared with a mark score threshold. In an event, the mark score for the at least one memory page exceeds the mark score threshold, then the at least one memory page is suitable for memory recovery.

Furthermore in the embodiment, based on identifying one or more memory regions, the MRM 314 advises the kernel in the electronic device 106 to recover the identified memory regions.

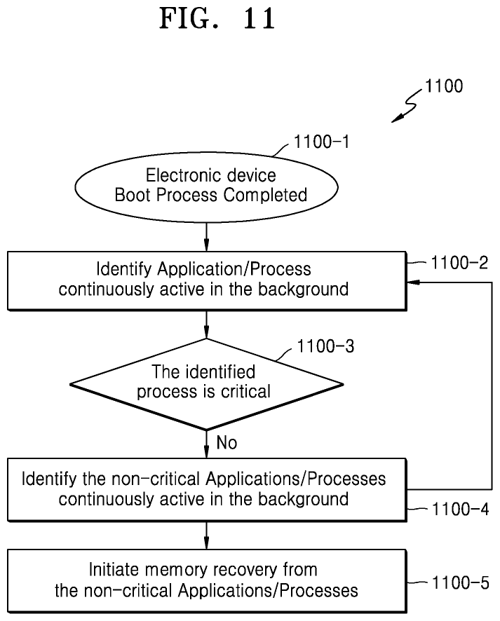

FIG. 11 illustrates an exemplary use case of the present disclosure associated with a post-boot memory optimization in the electronic device, according to various embodiments of the present disclosure.

In an embodiment of the present disclosure, the present disclosure may be relied upon to implement the post-boot memory optimization at the electronic device 106. FIG. 11 illustrates the exemplary use case for the post-boot memory optimization at the electronic device 106. At operation 1100-1, the boot process at the electronic device 106 is completed. Next at operation 1100-2, the electronic device 200 is configured to identify process or applications continuously active in the electronic device 106 background. At operation 1100-3, the electronic device 200 is configured to identify the process or application as a process critical to the functioning of the electronic device 106.

Next at operation 1100-4, the non-critical processes to the functioning of the electronic device 106 are identified and the process ID is stored. The process is repeated from 1100-2 to 1100-4, to identify non-critical processes. Thereafter, at operation 1100-5, memory recovery is initiated from the identified non-critical processes based on the solution provided in the present disclosure. Memory optimization in post-boot device enhances the user experience and improves the performance of critical processes or services in the electronic device 106.

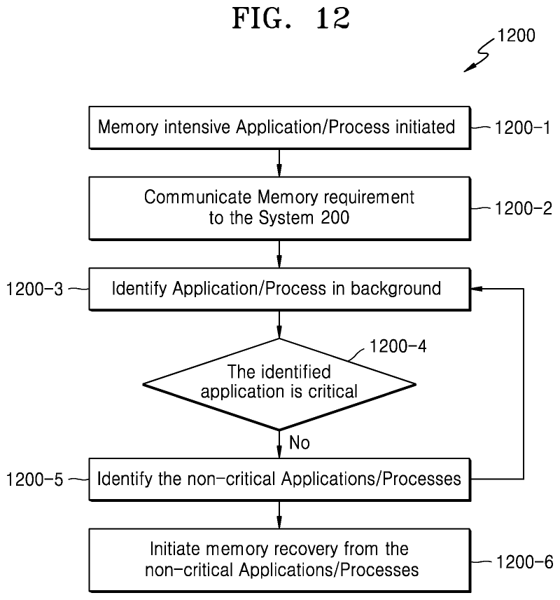

FIG. 12 illustrates an exemplary use case of the present disclosure associated with memory optimization in the electronic device executing a memory-intensive application, according to various embodiments of the present disclosure.

In an embodiment of the present disclosure, the present disclosure may be relied upon to implement the memory optimization at the electronic device 106 for executing memory-intensive processes. For example, the memory-intensive processes may include gaming applications, generative artificial intelligence (GenAI) applications, and the like.

At operation 1200-1, a memory-intensive application or process is initiated at the electronic device 106. Next at operation 1200-2, the memory-intensive application communicates memory requirements to the electronic device 200. Next at operation 1200-3, based on the memory requirement the system identifies applications or processes active or idle in the electronic device 106 background.

Next at 1200-4, the electronic device 200 identifies the criticality of the applications or processes in the electronic device 106 background. Next at 1200-5, the non-critical processes to the functioning of the electronic device 106 are identified and the process ID is stored. The process is repeated from 1200-3 to 1200-5, to identify non-critical processes. Thereafter, at operation 1200-6, memory recovery is initiated from the identified non-critical processes based on the solution provided in the present disclosure. Memory optimization during the execution of memory-intensive applications enhances the user experience and improves the performance of memory-intensive applications.

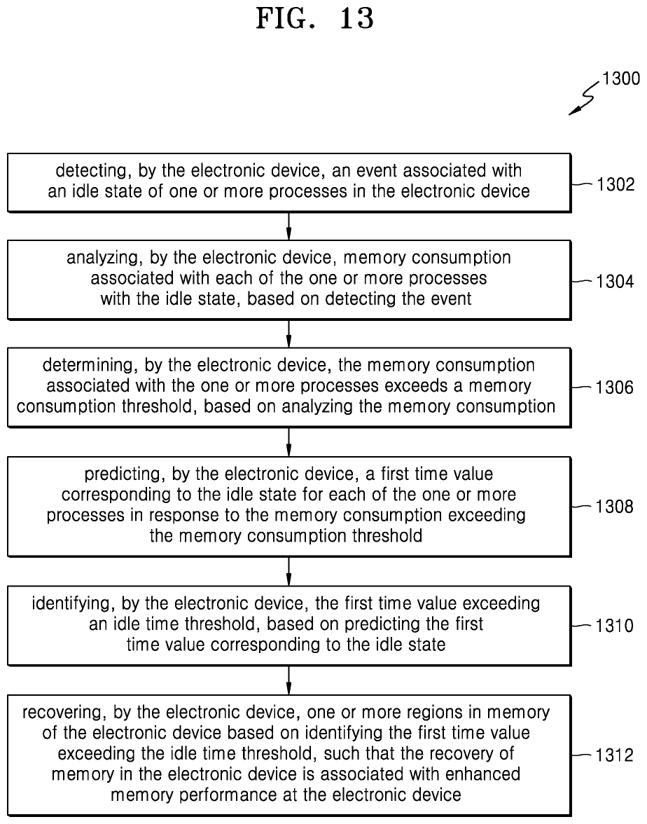

FIG. 13 illustrates an exemplary process flow comprising a method for recovering memory in an electronic device, according to various embodiments of the present disclosure. The method 1300 may be a computer-implemented method executed, for example, by the electronic device 200 and the modules 205. For the sake of brevity, the constructional and operational features of the electronic device 200 that are already explained in the description of FIGS. 1-12 are not explained in detail in the description of FIG. 13.

At operation 1302, the method 1300 may include detecting, by the electronic device, an event associated with an idle state of one or more processes in the electronic device.

At operation 1304, the method 1300 may include analyzing, by the electronic device, a memory consumption associated with each of the one or more processes with the idle state, based on detecting the event.

At operation 1306, the method 1300 may include determining, by the electronic device, the memory consumption associated with the one or more processes exceeds a memory consumption threshold, based on analyzing the memory consumption.

At operation 1308, the method 1300 may include predicting, by the electronic device, a first time value corresponding to the idle state for each of the one or more processes in response to the memory consumption exceeding the memory consumption threshold.

At operation 1310, the method 1300 may include identifying, by the electronic device, the first time value exceeding an idle time threshold, based on predicting the first time value corresponding to the idle state.

At operation 1312, the method 1300 may include recovering, by the electronic device, one or more regions in memory of the electronic device based on identifying the first time value exceeding the idle time threshold, such that the recovery of memory in the electronic device is associated with optimized memory performance at the electronic device.

While the above-discussed operations in FIG. 13 are shown and described in a particular sequence, the operations may occur in variations to the sequence in accordance with various embodiments. Further, a detailed description related to the various operations of FIG. 13 is already covered in the description related to FIGS. 1-12 and is omitted herein for the sake of brevity.

The present invention provides the following features:

The present disclosure provides a solution for memory recovery in the electronic device 106 without affecting the performance of active applications.

The present disclosure identifies the feasibility of the memory recovery and recovers memory systematically from memory regions suitable for the recovery process.

The present disclosure avoids insignificant memory recovery processes. The memory process is initiated when the recoverable memory exceeds a predetermined memory threshold.

Memory recovery is initiated for processes expected to remain in the idle state for a significant period of time. This enhances user experience in case the application is relaunched from the idle state.

The present disclosure is suitable for memory optimization in the post boot scenario at the electronic device.

The present disclosure is suitable for memory optimization to execute memory-intensive applications at the electronic device while maintaining the quality of user experience.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

According to an embodiment of the disclosure, the method for recovering memory in an electronic device is provided.

According to an embodiment of the disclosure, the method may include detecting, by the electronic device, an event associated with an idle state of one or more processes in the electronic device.

According to an embodiment of the disclosure, the method may include analyzing, by the electronic device, memory consumption associated with each of the one or more processes with the idle state, based on detecting the event.

According to an embodiment of the disclosure, the method may include determining, by the electronic device, the memory consumption associated with the one or more processes exceeds a memory consumption threshold, based on analyzing the memory consumption.

According to an embodiment of the disclosure, the method may include predicting, by the electronic device, a first time value corresponding to the idle state for each of the one or more processes in response to the memory consumption exceeding the memory consumption threshold.

According to an embodiment of the disclosure, the method may include identifying, by the electronic device, the first time value exceeding an idle time threshold, based on predicting the first time value corresponding to the idle state.

According to an embodiment of the disclosure, the method may include recovering, by the electronic device, one or more regions in memory of the electronic device based on identifying the first time value exceeding the idle time threshold, such that the recovery of memory in the electronic device is associated with enhanced memory performance at the electronic device.

According to an embodiment of the disclosure, the method may include retrieving a first memory consumption size from a first database.

According to an embodiment of the disclosure, the first memory consumption size may be associated with the memory consumption size of the idle state after first memory recovery.

According to an embodiment of the disclosure, the method may include retrieving a second memory consumption size for each of the one or more processes with the detected idle state.

According to an embodiment of the disclosure, the second memory consumption size may be associated with the memory consumption size of the idle state after subsequent memory recovery.

According to an embodiment of the disclosure, the method may include computing the difference between the first memory consumption size and the second memory consumption size.

According to an embodiment of the disclosure, the computed difference may correspond to the analyzed memory consumption associated with each of the one or more processes.

According to an embodiment of the disclosure, the method may include monitoring a plurality of parameters associated with the first time value.

According to an embodiment of the disclosure, the method may include predicting the first time value using an Artificial Intelligence (AI) based model, based on the monitoring of the plurality of parameters.

According to an embodiment of the disclosure, the plurality of parameters associated with the first time value may comprise usage pattern analysis parameters and resource utilization monitoring parameters.

According to an embodiment of the disclosure, the method may include identifying at least one memory region in the electronic device based on the scanning of memory tables associated with the one or more processes with corresponding the first time value exceeding the idle time threshold.

According to an embodiment of the disclosure, the method may include computing a mark score of at least one memory page in the at least one memory region based on the identification of the at least one memory region.

According to an embodiment of the disclosure, the mark score may be associated with suitability of the at least one memory page for recovering memory in the electronic device.

According to an embodiment of the disclosure, the method may include selecting the one or more memory regions from the at least one memory region for memory recovery.

According to an embodiment of the disclosure, the selection of the one or more regions may be based on the combined mark score of each of at least one memory page in the at least one memory region exceeding a mark score threshold.

According to an embodiment of the disclosure, the mark score of the at least one memory page may be computed based on type of the at least one memory page, access type of the at least one memory page, access frequency of the at least one memory page, and access age of the at least one memory page.

According to an embodiment of the disclosure, the method may include storing requests related to the memory recovery at the electronic device.

According to an embodiment of the disclosure, an electronic device may include at least one processor including processing circuitry, memory storing instructions that, when executed by the at least one processor individually or collectively is provided.

According to an embodiment of the disclosure, the instructions may be that, when executed by the at least one processor individually or collectively, may cause the electronic device to detect an event associated with an idle state of one or more processes in the electronic device.

According to an embodiment of the disclosure, the instructions may be that, when executed by the at least one processor individually or collectively, may cause the electronic device to analyze memory consumption associated with each of the one or more processes with the idle state, based on detecting the event.

According to an embodiment of the disclosure, the instructions may be that, when executed by the at least one processor individually or collectively, may cause the electronic device to determine the memory consumption associated with the one or more processes exceeds a memory consumption threshold, based on analyzing the memory consumption.

According to an embodiment of the disclosure, the instructions may be that, when executed by the at least one processor individually or collectively, may cause the electronic device to predict a first time value corresponding to the idle state for each of the one or more processes in response to the memory consumption exceeding the memory consumption threshold.

According to an embodiment of the disclosure, the instructions may be that, when executed by the at least one processor individually or collectively, may cause the electronic device to identify the first time value exceeding an idle time threshold, based on predicting the first time value corresponding to the idle state.

According to an embodiment of the disclosure, the instructions may be that, when executed by the at least one processor individually or collectively, may cause the electronic device to recover one or more regions in memory of the electronic device based on identifying the first time value exceeding the idle time threshold, such that the recovery of memory in the electronic device is associated with enhanced memory performance at the electronic device.

According to an embodiment of the disclosure, the instructions may be that, when executed by the at least one processor individually or collectively, may cause the electronic device to retrieve a first memory consumption size from a first database.

According to an embodiment of the disclosure, the first memory consumption size may be associated with the memory consumption size of the idle state after first memory recovery.

According to an embodiment of the disclosure, the instructions may be that, when executed by the at least one processor individually or collectively, may cause the electronic device to retrieve a second memory consumption size for each of the one or more processes with the detected idle state.

According to an embodiment of the disclosure, the second memory consumption size may be associated with the memory consumption size of the idle state after subsequent memory recovery.

According to an embodiment of the disclosure, the instructions may be that, when executed by the at least one processor individually or collectively, may cause the electronic device to compute the difference between the first memory consumption size and the second memory consumption size.

According to an embodiment of the disclosure, the computed difference may correspond to the analyzed memory consumption associated with each of the one or more processes.

According to an embodiment of the disclosure, the instructions may be that, when executed by the at least one processor individually or collectively, may cause the electronic device to monitor a plurality of parameters associated with the first time value.

According to an embodiment of the disclosure, the instructions may be that, when executed by the at least one processor individually or collectively, may cause the electronic device to predict the first time value using an Artificial Intelligence (AI) based model, based on the monitoring of the plurality of parameters.

According to an embodiment of the disclosure, the plurality of parameters associated with the first time value may comprise usage pattern analysis parameters and resource utilization monitoring parameters.

According to an embodiment of the disclosure, the instructions may be that, when executed by the at least one processor individually or collectively, may cause the electronic device to identify at least one memory region in the electronic device based on the scanning of memory tables associated with the one or more processes with corresponding the first time value exceeding the idle time threshold.

According to an embodiment of the disclosure, the instructions may be that, when executed by the at least one processor individually or collectively, may cause the electronic device to compute a mark score of at least one memory page in the at least one memory region based on the identification of the at least one memory region.

According to an embodiment of the disclosure, the mark score may be associated with suitability of the at least one memory page for recovering memory in the electronic device.

According to an embodiment of the disclosure, the instructions may be that, when executed by the at least one processor individually or collectively, may cause the electronic device to select the one or more memory regions from the at least one memory region for memory recovery.

According to an embodiment of the disclosure, the selection of the one or more regions may be based on the combined mark score of each of at least one memory page in the at least one memory region exceeding a mark score threshold.

According to an embodiment of the disclosure, the mark score of the at least one memory page may be computed based on type of the at least one memory page, access type of the at least one memory page, access frequency of the at least one memory page, and access age of the at least one memory page.

According to an embodiment of the disclosure, the electronic device may include one or more queues to store requests related to the memory recovery at the electronic device.

According to an embodiment of the disclosure, an electronic device may include at least one processor including processing circuitry, memory storing instructions that, when executed by the at least one processor individually or collectively is provided.

According to an embodiment of the disclosure, the instructions may be that, when executed by the at least one processor individually or collectively, may cause the at least one processor of the electronic device to detect an event associated with an idle state of one or more processes in the electronic device.

According to an embodiment of the disclosure, the instructions may be that, when executed by the at least one processor individually or collectively, may cause the at least one processor of the electronic device to analyze memory consumption associated with each of the one or more processes with the idle state, based on detecting the event.

According to an embodiment of the disclosure, the instructions may be that, when executed by the at least one processor individually or collectively, may cause the at least one processor of the electronic device to determine the memory consumption associated with the one or more processes exceeds a memory consumption threshold, based on analyzing the memory consumption.

According to an embodiment of the disclosure, the instructions may be that, when executed by the at least one processor individually or collectively, may cause the at least one processor of the electronic device to predict a first time value corresponding to the idle state for each of the one or more processes in response to the memory consumption exceeding the memory consumption threshold.

According to an embodiment of the disclosure, the instructions may be that, when executed by the at least one processor individually or collectively, may cause the at least one processor of the electronic device to identify the first time value exceeding an idle time threshold, based on predicting the first time value corresponding to the idle state.

According to an embodiment of the disclosure, the instructions may be that, when executed by the at least one processor individually or collectively, may cause the at least one processor of the electronic device to recover one or more regions in memory of the electronic device based on identifying the first time value exceeding the idle time threshold, such that the recovery of memory in the electronic device is associated with enhanced memory performance at the electronic device.

According to an embodiment of the disclosure, the instructions may be that, when executed by the at least one processor individually or collectively, may cause the at least one processor of the electronic device to retrieve a first memory consumption size from a first database.

According to an embodiment of the disclosure, the first memory consumption size may be associated with the memory consumption size of the idle state after first memory recovery.

According to an embodiment of the disclosure, the instructions may be that, when executed by the at least one processor individually or collectively, may cause the at least one processor of the electronic device to retrieve a second memory consumption size for each of the one or more processes with the detected idle state.

According to an embodiment of the disclosure, the second memory consumption size may be associated with the memory consumption size of the idle state after subsequent memory recovery.

According to an embodiment of the disclosure, the instructions may be that, when executed by the at least one processor individually or collectively, may cause the at least one processor of the electronic device to compute the difference between the first memory consumption size and the second memory consumption size.

According to an embodiment of the disclosure, the computed difference may correspond to the analyzed memory consumption associated with each of the one or more processes.

According to an embodiment of the disclosure, the instructions may be that, when executed by the at least one processor individually or collectively, may cause the at least one processor of the electronic device to monitor a plurality of parameters associated with the first time value.

According to an embodiment of the disclosure, the instructions may be that, when executed by the at least one processor individually or collectively, may cause the at least one processor of the electronic device to predict the first time value using an Artificial Intelligence (AI) based model, based on the monitoring of the plurality of parameters.

According to an embodiment of the disclosure, the plurality of parameters associated with the first time value may comprise usage pattern analysis parameters and resource utilization monitoring parameters.

According to an embodiment of the disclosure, the instructions may be that, when executed by the at least one processor individually or collectively, may cause the at least one processor of the electronic device to identify at least one memory region in the electronic device based on the scanning of memory tables associated with the one or more processes with corresponding the first time value exceeding the idle time threshold.

According to an embodiment of the disclosure, the instructions may be that, when executed by the at least one processor individually or collectively, may cause the at least one processor of the electronic device to compute a mark score of at least one memory page in the at least one memory region based on the identification of the at least one memory region.

According to an embodiment of the disclosure, the mark score may be associated with suitability of the at least one memory page for recovering memory in the electronic device.

According to an embodiment of the disclosure, the instructions may be that, when executed by the at least one processor individually or collectively, may cause the at least one processor of the electronic device to select the one or more memory regions from the at least one memory region for memory recovery.

According to an embodiment of the disclosure, the selection of the one or more regions may be based on the combined mark score of each of at least one memory page in the at least one memory region exceeding a mark score threshold.

According to an embodiment of the disclosure, the mark score of the at least one memory page may be computed based on type of the at least one memory page, access type of the at least one memory page, access frequency of the at least one memory page, and access age of the at least one memory page.

According to an embodiment of the disclosure, the electronic device may include one or more queues to store requests related to the memory recovery at the electronic device.

According to an embodiment of the disclosure, a computer readable medium storing one or more instructions is provided.

According to an embodiment of the disclosure, the instructions may be that, when executed by the at least one processor individually or collectively, may cause the electronic device to detect an event associated with an idle state of one or more processes in the electronic device.

According to an embodiment of the disclosure, the instructions may be that, when executed by the at least one processor individually or collectively, may cause the electronic device to analyze memory consumption associated with each of the one or more processes with the idle state, based on detecting the event.

According to an embodiment of the disclosure, the instructions may be that, when executed by the at least one processor individually or collectively, may cause the electronic device to determine the memory consumption associated with the one or more processes exceeds a memory consumption threshold, based on analyzing the memory consumption.

According to an embodiment of the disclosure, the instructions may be that, when executed by the at least one processor individually or collectively, may cause the electronic device to predict a first time value corresponding to the idle state for each of the one or more processes in response to the memory consumption exceeding the memory consumption threshold.

According to an embodiment of the disclosure, the instructions may be that, when executed by the at least one processor individually or collectively, may cause the electronic device to identify the first time value exceeding an idle time threshold, based on predicting the first time value corresponding to the idle state.

According to an embodiment of the disclosure, the instructions may be that, when executed by the at least one processor individually or collectively, may cause the electronic device to recover one or more regions in memory of the electronic device based on identifying the first time value exceeding the idle time threshold, such that the recovery of memory in the electronic device is associated with enhanced memory performance at the electronic device.

1. A method for recovering memory in an electronic device, the method comprising:
detecting, by the electronic device, an event associated with an idle state of a first process in the electronic device;
analyzing, by the electronic device, memory consumption associated with the first process in the idle state, based on the detecting the event;
determining, by the electronic device, the memory consumption associated with the first process exceeding a memory consumption threshold, based on the analyzing the memory consumption;
predicting, by the electronic device, a first time value corresponding to the idle state for the first process in response to the memory consumption exceeding the memory consumption threshold;
identifying, by the electronic device, the first time value exceeding an idle time threshold, based on predicting the first time value corresponding to the idle state; and
recovering, by the electronic device, one or more regions in memory of the electronic device based on identifying the first time value exceeding the idle time threshold, such that the recovered one or more regions in memory are available for use by another process.

2. The method of claim 1, wherein analyzing the memory consumption associated with the first process with the idle state comprises:
retrieving a first memory consumption size from a first database, wherein the first memory consumption size is associated with the memory consumption size of the idle state after first memory recovery;
retrieving a second memory consumption size for the first process with the idle state, wherein the second memory consumption size is associated with the memory consumption size of the idle state after subsequent memory recovery; and
computing a difference between the first memory consumption size and the second memory consumption size, wherein the computed difference corresponds to the analyzed memory consumption associated with the first process.

3. The method claim 1, wherein predicting the first time value for the first process comprises:
monitoring a plurality of parameters associated with the first time value; and
predicting the first time value using an Artificial Intelligence (AI) based model, based on the monitoring of the plurality of parameters.

4. The method of claim 3, wherein the plurality of parameters associated with the first time value comprises usage pattern analysis parameters and resource utilization monitoring parameters.

5. The method of claim 1, wherein recovering the one or more regions in the memory of the electronic device comprises:
identifying at least one memory region in the electronic device based on the scanning of memory tables associated with the first process with corresponding the first time value exceeding the idle time threshold;
computing a mark score of at least one memory page in the at least one memory region based on the identification of the at least one memory region, wherein the mark score is associated with suitability of the at least one memory page for recovering memory in the electronic device; and
selecting the one or more memory regions from the at least one memory region for memory recovery, wherein the selection of the one or more memory regions is based on the combined mark score of each of at least one memory page in the at least one memory region exceeding a mark score threshold.

6. The method of claim 5, wherein the mark score of the at least one memory page is computed based on type of the at least one memory page, access type of the at least one memory page, access frequency of the at least one memory page, and access age of the at least one memory page.

7. The method of claim 1, wherein the method further includes storing requests related to the memory recovery at the electronic device.

8. An electronic device comprising:
at least one processor comprising processing circuitry,
memory storing instructions that, when executed by the at least one processor individually or collectively, cause the electronic device to:
detect an event associated with an idle state of a first process in the electronic device;
analyze memory consumption associated with each of the first process with the idle state, based on detecting the event;
determine the memory consumption associated with the first process exceeding a memory consumption threshold, based on analyzing the memory consumption;
predict a first time value corresponding to the idle state for the first process in response to the memory consumption exceeding the memory consumption threshold;
identify the first time value exceeding an idle time threshold, based on predicting the first time value corresponding to the idle state; and
recover one or more regions in memory of the electronic device based on identifying the first time value exceeding the idle time threshold, such that the recovered one or more regions in memory are available for use by another process.

9. The electronic device of claim 8, wherein the one or more instructions, when executed by the at least one processor individually or collectively, further cause the device in analyzing the memory consumption associated with the first process with the idle state, to:
retrieve a first memory consumption size from a first database, wherein the first memory consumption size is associated with the memory consumption size of the idle state after first memory recovery;
retrieve a second memory consumption size for the first process with the idle state, wherein the second memory consumption size is associated with the memory consumption size of the idle state after subsequent memory recovery; and
compute a difference between the first memory consumption size and the second memory consumption size, wherein the computed difference corresponds to the analyzed memory consumption associated with the first process.

10. The electronic device of claim 8, wherein the one or more instructions, when executed by the at least one processor individually or collectively, further cause the device in predicting the first time value, to:
monitor a plurality of parameters associated with the first time value; and
predict the first time value using an Artificial Intelligence (AI) based model, based on the monitoring of the plurality of parameters.

11. The electronic device of claim 10, wherein the plurality of parameters associated with the first time value comprises usage pattern analysis parameters and resource utilization monitoring parameters.

12. The electronic device of claim 8, the one or more instructions, when executed by the at least one processor individually or collectively, further cause the device in recovering the one or more regions in the memory, to:
identify at least one memory region in the electronic device based on the scanning of memory tables associated with the first process with corresponding the first time value exceeding the idle time threshold;
compute a mark score of at least one memory page in the at least one memory region based on the identification of the at least one memory region, wherein the mark score is associated with suitability of the at least one memory page for recovering memory in the electronic device; and
select the one or more memory regions from the at least one memory region for memory recovery, wherein the selection of the one or more memory regions is based on the combined mark score of each of at least one memory page in the at least one memory region exceeding a mark score threshold.

13. The electronic device of claim 12, wherein the mark score of the at least one memory page is computed based on type of the at least one memory page, access type of the at least one memory page, access frequency of the at least one memory page, and access age of the at least one memory page.

14. The electronic device of claim 8, wherein the electronic device includes one or more queues to store requests related to the memory recovery at the electronic device.

15. A computer readable medium storing one or more instructions, wherein the one or more instructions, when executed by at least one processor, cause the at least one processor of an electronic device to:
detect an event associated with an idle state of a first process in the electronic device;
analyze memory consumption associated with first process with the idle state, based on detecting the event;
determine the memory consumption associated with the first process exceeding a memory consumption threshold, based on analyzing the memory consumption;
predict a first time value corresponding to the idle state for each of the first process in response to the memory consumption exceeding the memory consumption threshold;
identify the first time value exceeding an idle time threshold, based on predicting the first time value corresponding to the idle state; and
recover one or more regions in memory of the electronic device based on identifying the first time value exceeding the idle time threshold, such that the recovered one or more regions in memory are available for use by another process.
